(19) United States
(12) Patent Application Publication
(10) Pub. No.: US 2012/0139785 A1
(43) Pub. Date: Jun. 7, 2012

(54) SYSTEM FOR COLLECTING AND MANAGING RAINFALL ATTENUATION AND RAINFALL INTENSITY ON SATELLITE COMMUNICATIONS SYSTEM

(75) Inventors: Kyung Soo CHOI, Daejeon (KR); Jae Hoon KIM, Daejeon (KR); Do Seob AHN, Deajeon (KR)

(73) Assignee: ELECTRONICS AND TELECOMMUNICATIONS RESEARCH INSTITUTE, Daejeon (KR)

(21) Appl. No.: 13/307,558

(22) Filed: Nov. 30, 2011

(30) Foreign Application Priority Data
Dec. 1, 2010 (KR) 10-2010-0121313

(51) Int. Cl. G01S 19/26

(52) U.S. Cl. 342/357.65; 342/357.39

(57) ABSTRACT

Provided is a system for collecting and managing rainfall attenuation data and rainfall intensity data in a satellite communication system. The system may include: a satellite transmitter to transmit a satellite beacon signal; a Global Positioning System (GPS) to transmit a GPS signal; at least one data collecting apparatus to generate rainfall attenuation data about the satellite beacon signal when the satellite beacon signal is received from the satellite transmitter, and to generate rainfall intensity data within a valid path length of rainfall attenuation, to extract time information from the GPS signal, and to assign the time information to the rainfall attenuation data and the rainfall intensity data; and a data managing apparatus to receive, from the at least one data collecting apparatus, the rainfall attenuation data and the rainfall intensity data assigned with the time information, and to manage the received rainfall attenuation data and rainfall intensity data.

### CROSS-REFERENCE TO RELATED APPLICATION

This application claims the priority benefit of Korean Patent Application No. 10-2010-0121313, filed on Dec. 1, 2010, in the Korean Intellectual Property Office, the disclosure of which is incorporated herein by reference.

### BACKGROUND

1. Field of the Invention

Embodiments of the present invention relate to a system for collecting and managing rain attenuation data and rainfall intensity data in a satellite communication system.

2. Description of the Related Art

A satellite beacon signal used in a satellite communication system may be transmitted from a satellite transmitter that is positioned at the attitude of about 36,000 km.

The satellite beacon signal may be scattered and be attenuated due to raindrop, snow, and the like. An attenuation level of the satellite beacon signal occurring due to the raindrop is referred to as rainfall attenuation.

In general, an attenuation amount of the satellite beacon signal may vary based on the size of the raindrop, that is, the rainfall intensity and thus, there is a need to simultaneously measure the rainfall attenuation and the rainfall intensity.

In the conventional art, it was general to measure the rainfall attenuation and the rainfall intensity using separate apparatuses and then generate rainfall attenuation data and rainfall intensity data, and to transmit the rainfall attenuation data and the rainfall intensity data to a central processing apparatus or a management apparatus through a person's manipulation on each apparatus. During this process, immediate data transmission has not been performed due to the person's manipulation.

In addition, in countries having frequent regional torrential rains such as Korea, the rainfall intensity has needed to be measured in many regions to develop a rainfall attenuation prediction model. However, the rainfall attenuation and the rainfall intensity has been measured without using a valid path length of rainfall attenuation and thus, it was difficult to accurately measure the rainfall attenuation and the rainfall intensity depending on regions.

Also, rainfall attenuation data and rainfall intensity data having the identical time information may be matched and thereby be used. Each apparatus may obtain time to information for triggering a module included therein from a general purpose computer. However, when a time error occurs in the general purpose computer, or when the general purpose computer malfunctions, accurate time information may not be obtained. Accordingly, due to inaccurate generation time information associated with the rainfall attenuation data and the rainfall intensity data, the rainfall attenuation data and the rainfall intensity data may not be accurately matched.

### SUMMARY

An aspect of the present invention provides a system that may measure rainfall attenuation and rainfall intensity using a single apparatus, and transmit the measured rainfall attenuation and rainfall intensity to a data managing apparatus over an Ethernet communication network, thereby enabling rainfall attenuation data and rainfall intensity data to be automatically transmitted in real time and be managed.

Another aspect of the present invention also provides a system that may measure rainfall intensity in a plurality of regions based on a valid path length of rainfall attenuation and thereby collect and manage accurate rainfall attenuation data and rainfall intensity data.

Another aspect of the present invention also provides a system that may extract time information from a Global Positioning System (GPS) signal and may assign the time information to rainfall attenuation data and rainfall intensity data and thereby accurately match rainfall attenuation data and rainfall intensity data that are generated at the same time.

According to an aspect of the present invention, there is provided a system for collecting and managing rainfall attention data and rainfall intensity data in a satellite communication system, the system including: a satellite transmitter to transmit a satellite beacon signal; a GPS to transmit a GPS signal; at least one data collecting apparatus to generate rainfall attenuation data about the satellite beacon signal when the satellite beacon signal is received from the satellite transmitter, and to generate rainfall intensity data within a valid path length of rainfall attenuation, to extract time information from the GPS signal, and to assign the time information to the rainfall attenuation data and the rainfall intensity data; and a data managing apparatus to receive, from the at least one data collecting apparatus, the rainfall attenuation data and the rainfall intensity data assigned with the time information, and to manage the received rainfall attenuation data and rainfall intensity data.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a system for collecting and managing rainfall attenuation data and rainfall intensity data in a satellite communication system according to an embodiment of the present invention;

FIG. 2 is a block diagram illustrating a configuration of a data collecting apparatus to collect rainfall attenuation data and rainfall intensity data according to an embodiment of the present invention;

FIG. 3 is a diagram illustrating rainfall attenuation measuring modules installed in a plurality of regions according to an embodiment of the present invention; and

FIG. 4 is a flowchart illustrating a method of collecting and managing rainfall attenuation data and rainfall intensity data in a satellite communication system according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

When it is determined detailed description related to a related known function or configuration they may make the purpose of the present invention unnecessarily ambiguous in describing the present invention, the detailed description will be omitted here. Also, terminologies used herein are defined to appropriately describe the exemplary embodiments of the present invention and thus may be changed depending on a user, the intent of an operator, or a custom. Accordingly, the terminologies must be defined based on the following overall description of this specification.

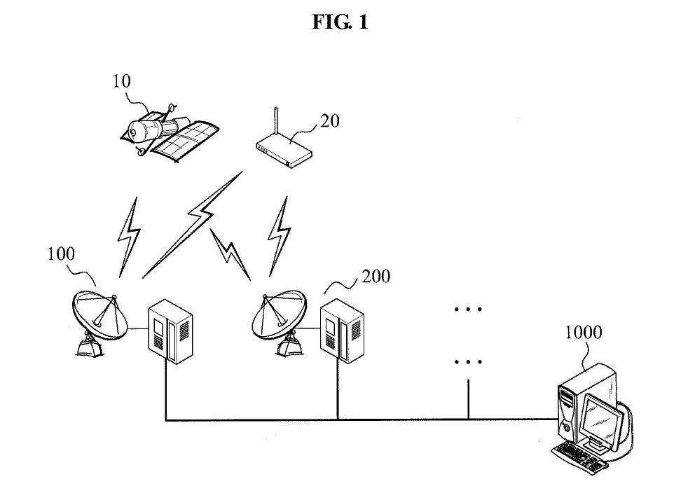

FIG. 1 is a diagram illustrating a system for collecting and managing rainfall attenuation data and rainfall intensity data (hereinafter, referred to as a “system”) in a satellite communication system according to an embodiment of the present invention.

Referring to FIG. 1, the system may include a satellite transmitter 10, a Global Positioning System (GPS) 20, a first data collecting apparatus 100, and a data managing apparatus 1000. In FIG. 1, the system may include at least one data collecting apparatus to measure rainfall attenuation and rainfall intensity and thereby collect rainfall attenuation data and rainfall intensity data. For example, the system may include the first data collecting apparatus 100 and a second data collecting apparatus 200 being installed in different regions, based on a valid path length of rainfall attenuation.

In FIG. 1, the first data collecting apparatus 100 and the second data collecting apparatus 200 are installed in different regions, however, have the same operation and configuration. Accordingly, in FIG. 1, the operation and the configuration will be described based on the first data collecting apparatus 100.

Also, even though the system including the first data collecting apparatus 100 and the second data collecting apparatus 200 are shown in FIG. 1, the further number of apparatuses may be installed in a plurality of regions within the valid path length of rainfall attenuation.

The satellite transmitter 10 may continuously transmit a satellite beacon signal at the altitude of about 36,000 km corresponding to a height of a geostationary orbit.

The GPS 20 may transmit a GPS signal. The first data collecting apparatus 100 may measure rainfall attenuation and rainfall intensity and thereby collect rainfall attenuation data and rainfall intensity data, which may also be referred to as “rainfall attenuation and rainfall intensity data”.

For example, when a satellite beacon signal is received from the satellite transmitter 10, the first data collecting apparatus 100 may generate rainfall attenuation data by measuring the rainfall attenuation of the received satellite beacon signal. The first data collecting apparatus 100 may generate rainfall intensity data by measuring the rainfall intensity within the valid path length of the rainfall attenuation.

When a GPS signal is received from the GPS 20, the first data collecting apparatus 100 may extract time information from the GPS signal and may assign the extracted time information to the rainfall attenuation data and the rainfall intensity data. For example, the first data collecting apparatus 100 may convert the GPS signal to 1 Pulse Per Second (PPS) to thereby extract time information from the 1PPS, and may stamp the time information in a front portion of the rainfall attenuation data and the rainfall intensity data to thereby generate a time frame.

The first data collecting apparatus 100 may verify the time frame and may match rainfall attenuation data and rainfall intensity data having corresponding time information and thereby store the matched rainfall attenuation data and rainfall intensity data in a storage medium.

The first data collecting apparatus 100 may transmit the matched rainfall attenuation data and rainfall intensity data to the data managing apparatus 1000. The first data collecting apparatus 100 and the data managing apparatus 1000 may transmit and receive data at predetermined intervals, for example, every five seconds over the Ethernet communication network.

The data managing apparatus 1000 may control the first data collecting apparatus 100 and the second data collecting apparatus 200. The data managing apparatus 1000 may receive rainfall attenuation data and rainfall intensity data from the first data collecting apparatus 100 and the second data collecting apparatus 200, and may manage the received rainfall attenuation data and rainfall intensity data. For example, the data managing apparatus 1000 may verify the time frame included in the rainfall attenuation data and the rainfall intensity data, may classify the rainfall attenuation data and the rainfall intensity data based on a region unit, a minute unit, a time unit, and a day unit using the time frame, and may thereby store the classified rainfall attenuation data and rainfall intensity data in a database.

Also, the data managing apparatus 1000 may generate statistical data with respect to the stored rainfall attenuation data and rainfall intensity data for each region and time. Also, the data managing apparatus 1000 may develop a rainfall attenuation prediction model using the rainfall attenuation data and the rainfall intensity data.

The data managing apparatus 1000 may display in real time rainfall attenuation data and rainfall intensity data that is received from the first data collecting apparatus 100, and may display the generated statistical data. Also, the data managing apparatus 1000 may monitor an operational state of the first data collecting apparatus 100 and the second data collecting apparatus 200, and may control an operation thereof based on the collected data.

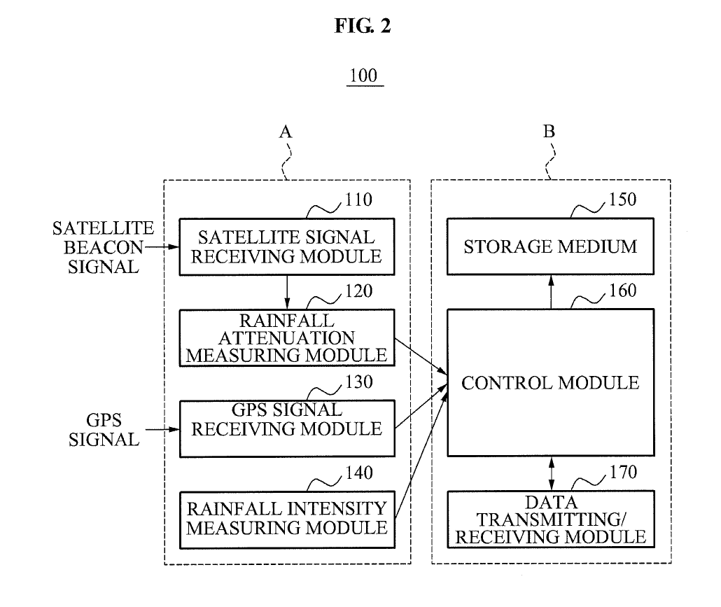

FIG. 2 is a block diagram illustrating a configuration of a data collecting apparatus to collect rainfall attenuation data and rainfall intensity data according to an embodiment of the present invention. Here, the data collecting apparatus may correspond to the first data collecting apparatus 100 of FIG. 1 and thus, be referred to as the data collecting apparatus 100.

Referring to FIG. 2, the data collecting apparatus 100 may include a satellite signal receiving module 110, a rainfall attenuation measuring module 120, a GPS signal receiving module 130, a rainfall intensity measuring module 140, a storage medium 150, a control module 160, and a data transmitting/receiving module 170. The data collecting apparatus 100 may be installed within a valid path length of rainfall attenuation.

The satellite signal receiving module 110 may receive a satellite beacon signal from the satellite transmitter 10. The satellite signal receiving module 110 may be an antenna for receiving the satellite beacon signal. The satellite signal receiving module 110 may low noise amplify a minute magnitude of the satellite beacon signal that is transmitted from the satellite transmitter 10, and may frequency down-convert the satellite beacon signal to a signal of an intermediate frequency band.

The rainfall attenuation measuring module 120 may generate rainfall attenuation data by measuring rainfall attenuation of the frequency down-converted satellite beacon signal. The rainfall attenuation measuring module 120 may measure the rainfall attenuation according to the following Equation 1:

A=aR^{b}Lₑ [Equation 1]

In Equation 1, A denotes the rainfall attenuation dB, R denotes the rainfall intensity mm/hr, each of a and b denotes an attenuation coefficient depending on a temperature of raindrop, a frequency, a polarization, a size distribution of raindrop particles, and the like, and Le denotes the valid path length. The rainfall intensity measured by the rainfall intensity measuring module 140 may be used.

The GPS signal receiving module 130 may receive a GPS signal from the GPS 20. The GPS signal receiving module 130 may be an active antenna. A common GPS antenna such as the active antenna may receive C/A(Coarse Acquisition) code of 1575.42±1.023 MHz as the GPS signal and thereby perform ground visibility calibration, receiving point measurement, speed/direction measurement, and the like using accurate time information and satellite orbit information.

The rainfall intensity measuring module 140 may generate rainfall intensity data by measuring the rainfall intensity. The rainfall intensity measuring module 140 may measure the rainfall intensity using an optical scheme and thus, may include a transmitting lens, a receiving lens, and a control configuration. The rainfall intensity measuring module 140 may emit an infrared (IR) signal for the rainfall intensity measurement towards a three-dimensional (3D) space using the transmitting lens, and may receive the IR signal reflected from the 3D space using the receiving lens.

The rainfall intensity measuring module 140 may compute a signal change amount by comparing the emitted IR signal and the reflected IR signal using the control configuration, and may generate the rainfall intensity data by measuring the rainfall intensity corresponding to the signal change amount.

At least one rainfall intensity measuring module 140 may be installed within the valid path length of rainfall attenuation. For example, a plurality of rainfall intensity modules 140 may be installed.

The control signal 160 may receive a GPS signal, rainfall attenuation data, and rainfall intensity data.

The control module 160 may convert the GPS signal to 1PPS, and may extract time information, for example, Time of Day (ToD) from the 1PPS. The 1PPS may be National Marine Electronics Association (NMEA) data that includes time information and location information. The control module 160 may stamp the extracted time information in a front portion of the rainfall attenuation data and the rainfall intensity data and thereby generate a time frame. For example, the control module 160 may assign the extracted time information to the front portion of the rainfall attenuation data and the rainfall intensity data in a time frame form.

The control module 160 may verify the time frame that is included in the front portion of each of the rainfall attenuation data and the rainfall intensity data, and may match the rainfall attenuation data and the rainfall intensity data having corresponding time information. The time information may include year, month, day, and time information.

The control module 160 may verify the year, month, day, and time information from the time frame, and may match the rainfall attenuation data and the rainfall intensity data having corresponding year, month, day, and time information.

The control module 160 may store, in the storage medium 150, the rainfall attenuation data and the rainfall intensity data that are matched based on a time information unit, and may control the data transmitting/receiving module 170 to transmit the stored rainfall attenuation data and rainfall intensity data to the data managing apparatus 1000 at predetermined intervals over the Ethernet communication network. The control module 160 may access a pre-registered Transmission Control Protocol/Internet Protocol (TCP/IP) of the data managing apparatus 1000 over the Ethernet communication network.

The control module 160 may transmit in real time the rainfall attenuation data and the rainfall intensity data to the data managing apparatus 1000 over the Ethernet communication network, thereby decreasing a manpower cost and enhancing a data transmission rate.

The data collecting apparatus 100 of FIG. 2 may generate rainfall attenuation data and rainfall intensity data by measuring the rainfall attenuation and the rainfall intensity, and may transmit the generated rainfall attenuation data and rainfall intensity data to the data managing apparatus 1000 in real time and automatically. Accordingly, it is possible to decrease a manpower cost used for collecting and transmitting rainfall attenuation data and rainfall intensity data.

Also, the data collecting apparatus 100 may install the rainfall intensity measuring modules 140 in different regions within the valid path length of rainfall attenuation and thereby more accurately measure the rainfall attenuation and the rainfall intensity based on the valid path length.

Also, the data collecting apparatus 100 may extract time information from a GPS signal and assign the extracted time information to rainfall attenuation data and rainfall intensity data, thereby more accurately matching the rainfall attenuation data and rainfall intensity data that are generated at the same time. Accordingly, it is possible to more accurately generate statistical data and a rainfall attenuation prediction model.

Also, even though the data collecting apparatus 100 of FIG. 2 is configured to include the satellite signal receiving module 110, the rainfall attenuation measuring module 120, the GPS signal receiving module 130, the rainfall intensity measuring module 140, the storage medium 150, the control module 160, and the data transmitting/receiving module 170, the data collecting apparatus 100 may be configured as two apparatuses that include a signal receiving and measuring configuration A and a data collecting configuration B, respectively.

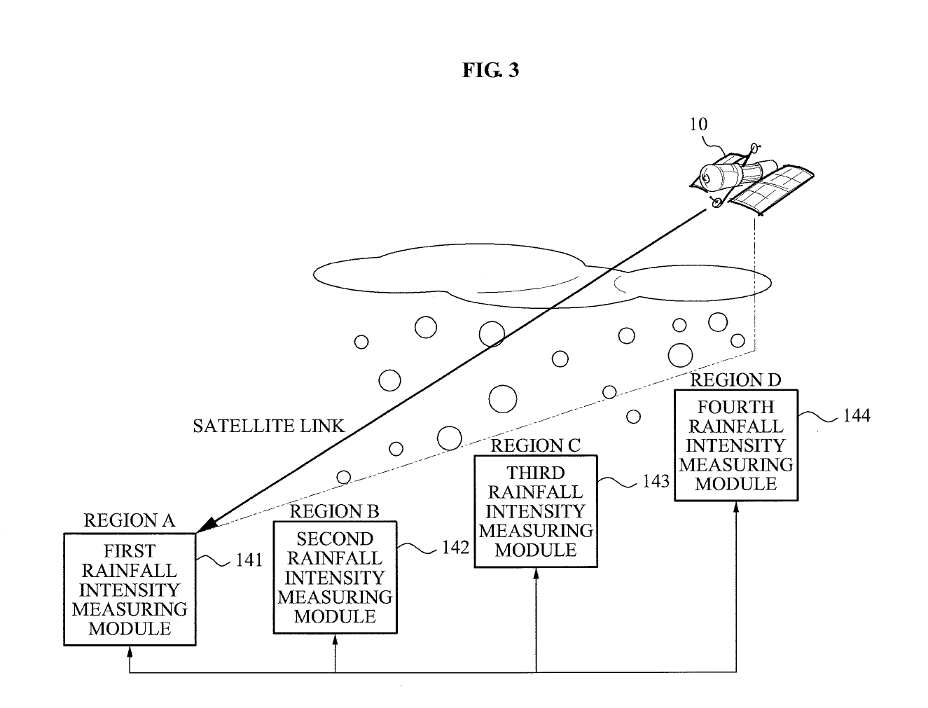

FIG. 3 is a diagram illustrating rainfall attenuation measuring modules installed in a plurality of regions according to an embodiment of the present invention.

Referring to FIG. 3, a satellite beacon signal transmitted from the satellite transmitter 110 positioned at the altitude of about 36,000 km may be scattered and thereby be attenuated while passing raindrops falling from clouds afloat at the altitude of about 4 km.

When raindrops uniformly fall within the valid path length of rainfall attenuation with respect to the satellite beacon signal, it is possible to measure the rainfall attenuation and the rainfall intensity using a single rainfall intensity measuring module. However, unlike regions B, C, and D, there is no raindrop in region A. Thus, even though the rainfall intensity is not measured, a satellite beacon signal may pass raindrops and thereby be received. Accordingly, the rainfall attenuation may be measured. That is, since the rainfall attenuation may be measured in a state where there is no measured rainfall intensity, it may be difficult to use the measured rainfall attenuation for a rainfall attenuation prediction model. Accordingly, the data collecting apparatus 100 may include first through fourth rainfall intensity measuring modules 141, 142, 143, and 144 within the valid path length of rainfall attenuation with respect to the received satellite beacon signal.

Within the valid path length of rainfall attenuation with respect to the satellite beacon signal, the first rainfall intensity measuring module 141 may be installed in the region A and the second rainfall intensity measuring module 142 may be installed in the region B. Also, the third rainfall intensity measuring module 143 may be installed in the region C and the fourth rainfall intensity measuring module 144 may be installed in the region D.

The first through the fourth rainfall intensity measuring modules 141, 142, 143, and 144 may generate rainfall intensity data by measuring the rainfall intensity at the same time intervals according to control of the control module 160. The generated rainfall intensity data may include region information about the regions A, B, C, and D where the first through the fourth rainfall intensity measuring modules 141, 142, 143, and 144 are respectively installed.

The control module 160 may verify time information and region information that is included in plural rainfall intensity data, classify a rainfall type, rainfall intensity, and the like based on a time and a region, and thereby generate statistical data.

Also, even though the first rainfall intensity measuring module 141 is installed within the valid path length of rainfall attenuation, the average rainfall intensity data may be generated using the rainfall intensity data generated in the second to the fourth rainfall intensity measuring modules 142, 143, and 144, excluding the first rainfall intensity measuring module 141 installed in the region A where there is no raindrop. The rainfall attenuation measuring module 120 may measure the rainfall attenuation by applying the average rainfall intensity data to Equation 1.

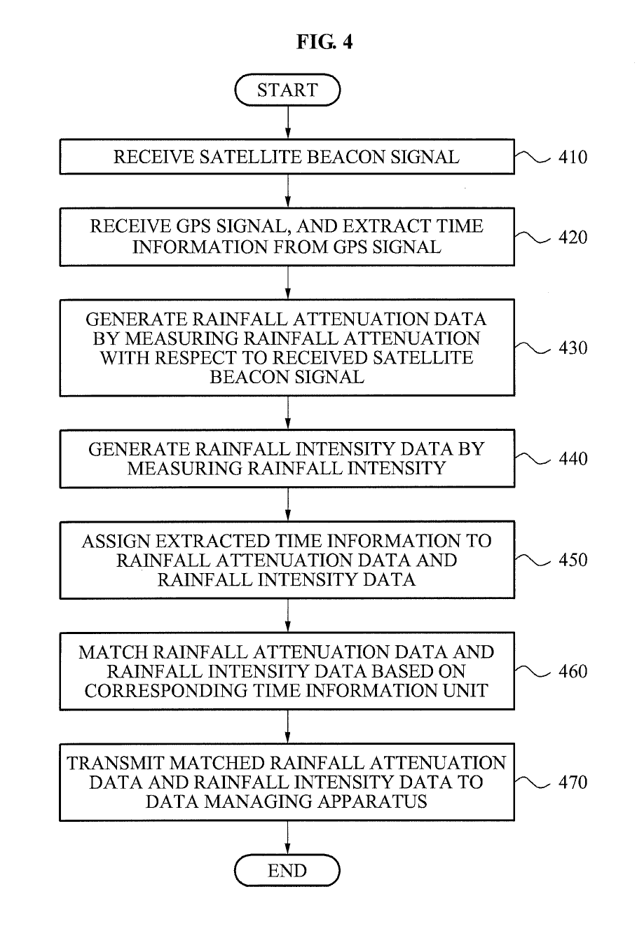

FIG. 4 is a flowchart illustrating a method of collecting and managing rainfall attenuation data and rainfall intensity data in a satellite communication system according to an embodiment of the present invention.

Referring to FIG. 4, in operation 410, the data collecting apparatus 100 may receive a satellite beacon signal from the satellite transmitter 10. In operation 420, the data collecting apparatus 100 may receive a GPS signal from a GPS 20, and may extract time information from the GPS signal. The data collecting apparatus 100 may receive the satellite beacon signal and the GPS signal at predetermined time intervals.

In operation 430, the data collecting apparatus 100 may generate rainfall attenuation data by measuring the rainfall attenuation with respect to the received satellite beacon signal.

In operation 440, the data collecting apparatus 100 may generate rainfall intensity data by measuring the rainfall intensity in at least one region within the valid path length of rainfall attenuation. The rainfall intensity measuring module 140 for measuring the rainfall intensity may be installed in at least one region that is included within the valid path length and may also be installed in a plurality of regions. The rainfall intensity measuring module 140 may measure the rainfall intensity using a transmitting lens and a receiving lens. For example, the rainfall intensity measuring module 140 may compute a signal change amount of an IR signal that is emitted towards a 3D space using the transmitting lens and then is reflected from the 3D space and thereby is received using the receiving lens. The rainfall intensity measuring module 140 may generate the rainfall intensity data by measuring the rainfall intensity corresponding to the computed signal change amount.

In operation 450, the data collecting apparatus 100 may assign, to the rainfall attenuation data and the rainfall intensity data, time information that is extracted from the GPS signal.

In operation 460, the data collecting apparatus 100 may match the rainfall attenuation data and the rainfall intensity data assigned with the time information based on a corresponding time information unit.

In operation 470, the data collecting apparatus 100 may transmit the matched rainfall attenuation data and rainfall intensity data to the data managing apparatus 1000 and thereby manage the rainfall attenuation data and the rainfall intensity data.

According to the method of FIG. 4, it is possible to collect rainfall attenuation data and rainfall intensity data close to an actual circumstance, and to more accurately generate statistical data and a rainfall attenuation prediction model using the collected rainfall attenuation data and rainfall intensity data.

According to embodiments of the present invention, a system for collecting and measuring rainfall attenuation data and rainfall intensity data may transmit the rainfall attenuation data and rainfall intensity data to a data managing apparatus in real time over an Ethernet communication system, thereby decreasing a manpower cost and enhancing a data transmission rate.

Also, the system may collect and manage accurate rainfall attenuation data and rainfall intensity data by measuring the rainfall intensity in a plurality of regions based on a valid path length of rainfall attenuation.

Also, the system may accurately match rainfall attenuation data and rainfall intensity data, generated at the same time, by extracting time information from a GPS signal and by assigning the extracted time information to the rainfall attenuation data and rainfall intensity data.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments.

Instead, it would be appreciated by those skilled in the art that changes may be made to these exemplary embodiments without departing from the principles and spirit of the invention, the scope of which is defined by the claims and their equivalents.

What is claimed is:

1. A system for collecting and managing rainfall attention data and rainfall intensity data in a satellite communication system, the system comprising:
a satellite transmitter to transmit a satellite beacon signal;
a Global Positioning System (GPS) to transmit a GPS signal;
at least one data collecting apparatus to generate rainfall attenuation data about the satellite beacon signal when the satellite beacon signal is received from the satellite transmitter, and to generate rainfall intensity data within a valid path length of rainfall attenuation, to extract time information from the GPS signal, and to assign the time information to the rainfall attenuation data and the rainfall intensity data; and
a data managing apparatus to receive, from the at least one data collecting apparatus, the rainfall attenuation data and the rainfall intensity data assigned with the time information, and to manage the received rainfall attenuation data and rainfall intensity data.

2. The system of claim 1, wherein each of the at least one data collecting apparatus comprises:
a satellite signal receiving module to receive the satellite beacon signal from the satellite transmitter, and to frequency down-convert the satellite beacon signal to a signal of an intermediate frequency band;
a GPS signal receiving module to receive the GPS signal from the GPS;
a rainfall attenuation measuring module to generate the rainfall attenuation data by measuring rainfall attenuation of the satellite beacon signal that is converted to the intermediate frequency band;
a rainfall intensity measuring module being provided within the valid path length of the rainfall attenuation to generate the rainfall intensity data by measuring the rainfall intensity;
a control module to extract time information from the GPS signal, to assign the time information to the rainfall attenuation data and the rainfall intensity data, and to store the rainfall attenuation data and the rainfall intensity data in a recording medium through matching thereof based on a corresponding time information unit; and
a data transmitting/receiving module to transmit the matched rainfall attenuation data and rainfall intensity data to the data managing apparatus according to a control of the control module.

3. The system of claim 2, wherein the control module converts the GPS signal to 1 Pulse Per Second (PPS) to thereby extract time information from the 1PPS, and stamps the time information in a front portion of the rainfall attenuation data and the rainfall intensity data to thereby generate a time frame.

4. The system of claim 2, wherein the control module controls the data transmitting/receiving module to transmit the matched rainfall attenuation data and rainfall intensity data to the data managing apparatus over an Ethernet communication network.
